(19) United States
(12) Patent Application Publication
(10) Pub. No.: US 2018/0071634 A1
(43) Pub. Date: Mar. 15, 2018

(54) CONTEXTUAL GAMER PROFILE

(71) Applicant: Microsoft Technology Licensing, LLC, Redmond, WA (US)

(72) Inventors: Carlos Carvallo, Sammamish, WA (US); Lee Steg, Kirkland, WA (US); Jorge Gabuardi Gonzalez, Seattle, WA (US); Robert Smith, Seattle, WA (US)

(73) Assignee: Microsoft Technology Licensing, LLC, Redmond, WA (US)

(21) Appl. No.: 15/261,497

(22) Filed: Sep. 9, 2016

(51) Int. Cl. A63F 13/798; A63F 13/25; A63F 13/32; A63F 13/33; A63F 13/335; A63F 13/35; A63F 13/92; A63F 13/2145; A63F 13/803

(52) U.S. Cl. CPC A63F 13/798; A63F 13/25; A63F 13/32; A63F 13/33; A63F 13/335; A63F 2300/407; A63F 13/92; A63F 13/2145; A63F 13/803; A63F 2300/8017; A63F 2300/1075; A63F 13/35

(57) ABSTRACT

Methods and apparatus are disclosed for a user interface control that can be used to display individual and aggregated data for a plurality of computer applications. In one example of the disclosed technology, an application hub system provides a user interface control to invoke applications, including an entity browser component configured to generate display data for a selected portion of credibility data and/or personalization items for a selected user including application-specific data views for the selected entity associated with an individual application and system-wide data views including data for the selected user combined across multiple applications. The system further includes a configuration component to select a subset of the credibility data for display with the entity browser component and an application invocation component configured to launch a selected one of the applications using the user interface control provided by the application hub system.

### BACKGROUND

Existing applications generate usage statistics for certain aspects of an individual application. For example, in a gaming application context, a game may be programmed to display a user profile listing achievements, previously defined by the game developer, that have been accomplished by a game player/user. For example, in-game achievements can be displayed for completing pre-defined quests within an individual game. Current displays of statistics and gaming context are severely limited and fail to provide a contextual picture of player performance. Thus, there is ample opportunity for improvements in technologies related to user interfaces.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Further, any trademarks used herein are the property of their respective owners.

Methods, apparatus, and computer-readable storage devices are disclosed for providing user interfaces and cross-application statistics tracking systems for collecting and displaying application-specific and aggregated data for two or more applications. In multi-user examples, an application hub system provides information for user interface controls that allow a user to evaluate properties of other users, such as the other user's credibility, skill level, or other suitable criteria, and to select one or more of these users to participate in a multi-user application. For example, a multi-player gaming session can be invoked by browsing contextual game profile information, including cumulative player statistics, high scores, and achievements, displayed for a number of different users and launching an application that is selected using disclosed user interface controls provided by the application hub system, thereby providing an interface for effectively evaluating credibility of other users of the system.

In some examples of the disclosed technology, an application hub system provides data for a user interface control including an entity browser component configured to generate display data for application-specific and system-wide data, a configuration component to select a subset of credibility data for display, and an application invocation component configured to launch a selected one of a plurality of applications. In some examples, an interactive control is provided to browse statistics for a user including individual game and aggregate statistics for the user across two or more games. In some examples, an application programming interface (API) is provided including a title-callable user interface (TCUI) that includes functions to generate, store, and use selected data across a number of different applications.

The foregoing and other objects, features, and advantages of the disclosed technology will become more apparent from the following detailed description, which proceeds with reference to the accompanying figures. As described herein, a variety of other features and advantages can be incorporated into the technologies as desired.

### BRIEF DESCRIPTION OF THE DRAWINGS

FIG. 1 illustrates an example environment in which disclosed apparatus and methods can be implemented, in certain examples of the disclosed technology.

FIGS. 2A-2I illustrate different states of a user interface control displaying data, as can be performed in certain examples of the disclosed technology.

FIG. 3 illustrates another example of an interactive control that can be used to display data, as can be used in certain examples of the disclosed technology.

FIG. 4 illustrates another example of a user interface control that can be implemented in certain examples of the disclosed technology.

FIG. 5 illustrates another example of a user interface control that can be implemented in certain examples of the disclosed technology.

FIG. 6 is a flowchart outlining an example method of displaying individual and aggregate data for a user with an interactive control interface, as can be performed in certain examples of the disclosed technology.

FIG. 7 is a flowchart outlining an example method of launching an application with an interactive control interface, as can be performed in certain examples of the disclosed technology.

FIG. 8 is a flowchart outlining an example method of launching a multi-player game session with an interactive control, as can be performed in certain examples of the disclosed technology.

FIG. 9 is a flowchart outlining an example method of providing application and aggregated display data using a TCUI, as can be performed in certain examples of the disclosed technology.

FIG. 10 is a block diagram illustrating a suitable computing environment for implementing certain embodiments of the disclosed technology.

FIG. 11 is a block diagram illustrating an example mobile device that can be used in conjunction with certain embodiments of the disclosed technology.

FIG. 12 is block diagram illustrating an example cloud-support environment that can be used in conjunction with certain embodiments of the disclosed technology.

### DETAILED DESCRIPTION

### I. GENERAL CONSIDERATIONS

This disclosure is set forth in the context of representative embodiments that are not intended to be limiting in any way.

As used in this application the singular forms “a,” “an,” and “the” include the plural forms unless the context clearly dictates otherwise. Additionally, the term “includes” means “comprises.” Further, the term “coupled” encompasses mechanical, electrical, magnetic, optical, as well as other practical ways of coupling or linking items together, and does not exclude the presence of intermediate elements between the coupled items. Furthermore, as used herein, the term “and/or” means any one item or combination of items in the phrase.

The systems, methods, and apparatus described herein should not be construed as being limiting in any way. Instead, this disclosure is directed toward all novel and non-obvious features and aspects of the various disclosed embodiments, alone and in various combinations and subcombinations with one another. The disclosed systems, methods, and apparatus are not limited to any specific aspect or feature or combinations thereof, nor do the disclosed things and methods require that any one or more specific advantages be present or problems be solved. Furthermore, any features or aspects of the disclosed embodiments can be used in various combinations and subcombinations with one another.

Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed things and methods can be used in conjunction with other things and methods. Additionally, the description sometimes uses terms like “produce,” “generate,” “display,” “receive,” “emit,” “verify,” “execute,” “initiate,” “launch,” and “invoke” to describe the disclosed methods. These terms are high-level descriptions of the actual operations that are performed. The actual operations that correspond to these terms will vary depending on the particular implementation and are readily discernible by one of ordinary skill in the art.

Theories of operation, scientific principles, or other theoretical descriptions presented herein in reference to the apparatus or methods of this disclosure have been provided for the purposes of better understanding and are not intended to be limiting in scope. The apparatus and methods in the appended claims are not limited to those apparatus and methods that function in the manner described by such theories of operation.

Any of the disclosed methods can be implemented as computer-executable instructions stored on one or more computer-readable media (e.g., computer-readable media, such as one or more optical media discs, volatile memory components (such as DRAM or SRAM), or nonvolatile memory components (such as hard drives)) and executed on a computer (e.g., any commercially available computer, including smart phones or other mobile devices that include computing hardware). Any of the computer-executable instructions for implementing the disclosed techniques, as well as any data created and used during implementation of the disclosed embodiments, can be stored on one or more computer-readable media (e.g., computer-readable storage media). The computer-executable instructions can be part of, for example, a dedicated software application or a software application that is accessed or downloaded via a web browser or other software application (such as a remote computing application). Such software can be executed, for example, on a single local computer (e.g., with general-purpose processors executing on any suitable commercially available computer) or in a network environment (e.g., via the Internet, a wide-area network, a local-area network, a client-server network (such as a cloud computing network), or other such network) using one or more network computers.

For clarity, only certain selected aspects of the software-based implementations are described. Other details that are well known in the art are omitted. For example, it should be understood that the disclosed technology is not limited to any specific computer language or program. For instance, the disclosed technology can be implemented by software written in C, C++, C#, Java, or any other suitable programming language. Likewise, the disclosed technology is not limited to any particular computer or type of hardware. Certain details of suitable computers and hardware are well-known and need not be set forth in detail in this disclosure.

Furthermore, any of the software-based embodiments (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, software applications, cable (including fiber optic cable), magnetic communications, electromagnetic communications (including RF, microwave, and infrared communications), electronic communications, or other such communication means.

### II. EXAMPLE NETWORKED COMPUTING ENVIRONMENT

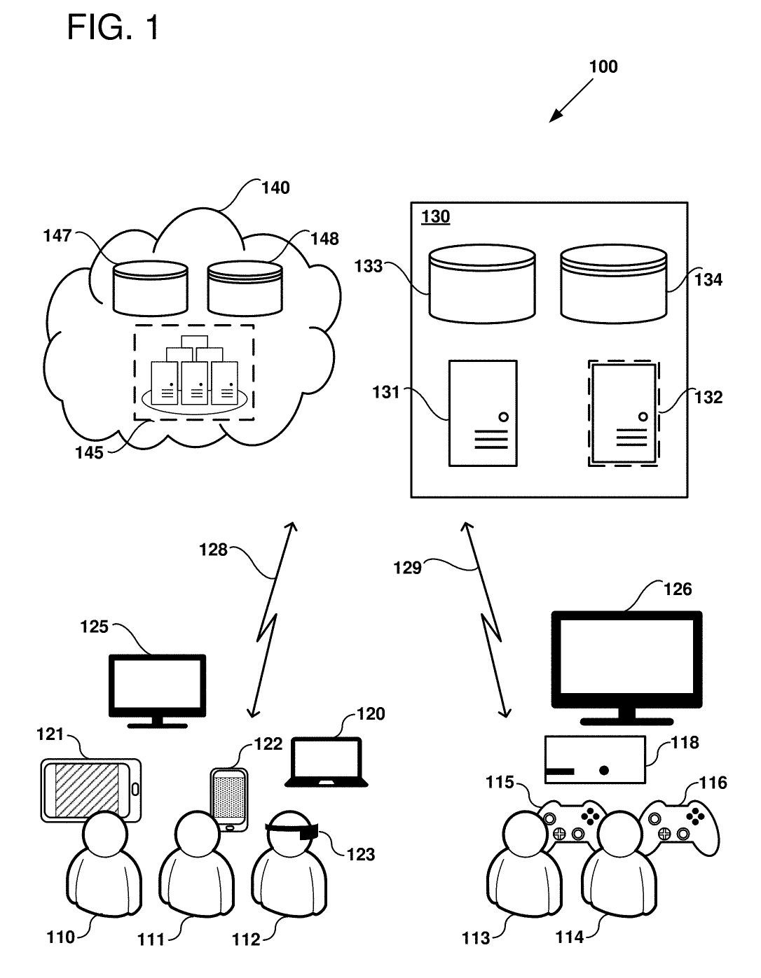

FIG. 1 is a block diagram 100 outlining an example networked computing environment in which certain examples of the disclosed technology can be implemented. For example, disclosed methods for displaying a contextual gamer card including the use of interactive controls that can be used to browse combined application-specific and aggregated statistics for users and to launch applications can be implemented in the environment of FIG. 1. Further, the environment can support an application hub system that provides user interface controls for invoking a selected application of a plurality of two or more applications. In some examples, the depicted environment can be implemented using a title callable user interface (TCUI) that enables applications to integrate with an application hub system.

As shown in FIG. 1, a number of application users 110-114 are using a number of different computing devices to the networked computer environment. Examples of suitable computing devices include, but are not limited to, a laptop computer 120, a tablet computer 121, smartphone 122, and virtual reality or augmented reality headwear 123. In some examples, some of the computing devices can be coupled to a display 125 or 126, and in some examples the displays themselves include smart TV functionality which allows for performing some of the disclosed methods. Three of the users 110-112 shown are currently located at the same location and their computing devices can communicate with each other using, for example, a local area network (LAN). Two other users 113 and 114 are currently at a different location from the first three users. Each of these users 113 and 114 is using a game controller 115 or 116 respectively to provide input to a gaming console 118, another example of a computing device. Both the first computing devices at the first location and the gaming consoles can be connected to a wider area computer network, for example the internet, using network connections 128 and 129 implemented with a suitable computer networking technology. Computing resources that can be accessed in the Internet include a dedicated networked server 130, which can include one or more of: a server computer 131, a virtual server 132, a storage 133, and/or a database 134. Further, the computing devices, including the gaming console 118, can alternatively be connected to computing resources located in a computing cloud 140. The computing cloud 140 includes an array of virtual servers 145 that can be provisioned on demand in order to provide functionality for performing certain disclosed methods. The computer cloud also hosts on-demand storage 147 and databases 148 that can be used to implement certain disclosed methods.

In some examples, a method of displaying an interactive control with a contextual interface includes providing an interactive control to browse data for an individual application along with aggregate statistics that are collected two or more allocations. Information for the interactive control can be generated at one or more of the following locations: at any of the computing devices, at the gaming console 118, at the server 130, or within the computing cloud 140. These systems can also be used to provide disclosed methods of accessing and launching applications, for example by allowing a user to browse data indicating credibility and other aspects of a number of users and select one of the users to join in multi-player game session or other multi-user application.

In some examples, some or all of these components are used to form an application hub system that provides user interface controls for invoking a plurality of applications. The application hub system can include an entity browser component configured to generate display data for a selected portion of credibility data for one or more entities, a configuration component that is configured to select a subset of credibility data for display by the entity browser component, and/or an application invocation component that is configured to launch a selected one of the plurality of applications. In some examples, the entity browser component can be used to browse users of one or more applications, such as games. In other examples, other entities are browsed instead of or in addition to users (e.g., organizations, teams, or other entities). The selected application can be selected using the interface control that is provided by the application hub system. In some examples, computer executable instructions for implementing the application hub system are located remotely, for example at the server 130 or in the computing cloud 140. In other examples, some or all of the computer executable instructions used to implement the application hub system are located on one or more of the computing devices, for example, the gaming console 118.

As will be readily understood by one of ordinary skill in the relevant art, a variety of communication technologies can be used to connect the components depicted in FIG. 1 including, for example the internet, intranets, cable, including fiber optic technologies, magnetic communication, electromagnetic communication, including RF, microwave, and infrared communications or other suitable communication technologies.

### III. FIRST EXAMPLE USER INTERFACE PROVIDING AN INTERACTIVE CONTROL

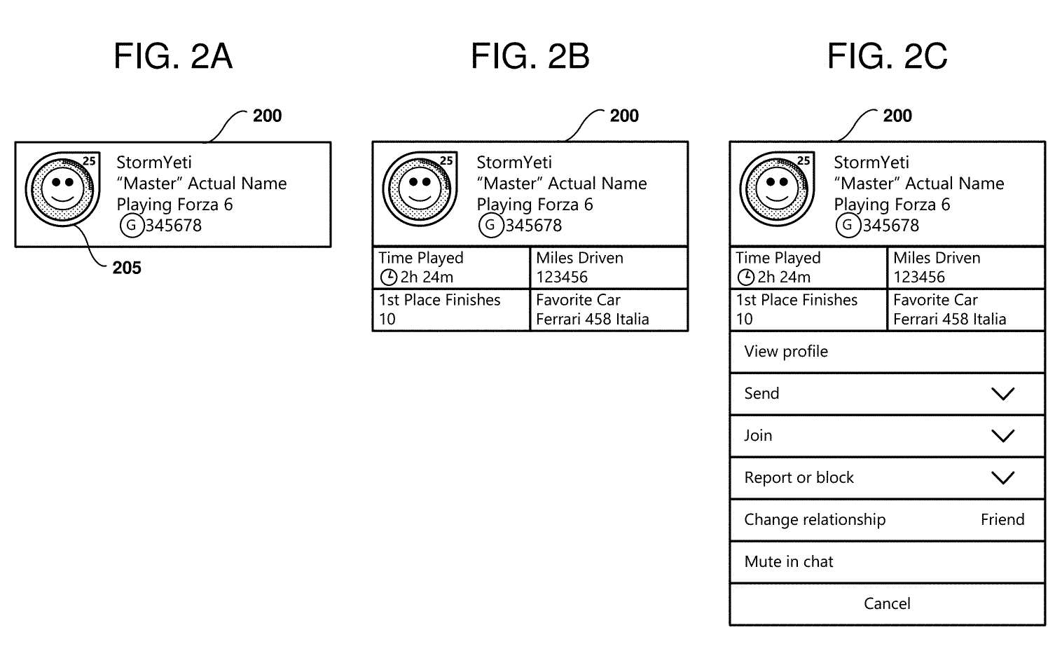

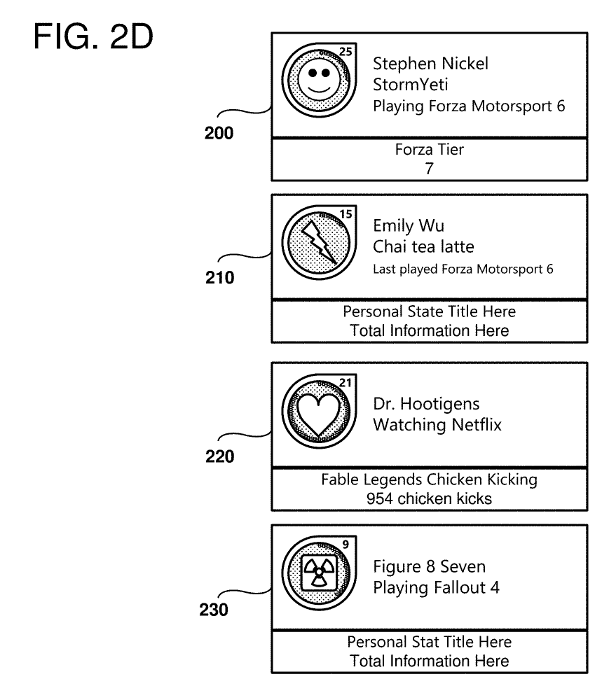

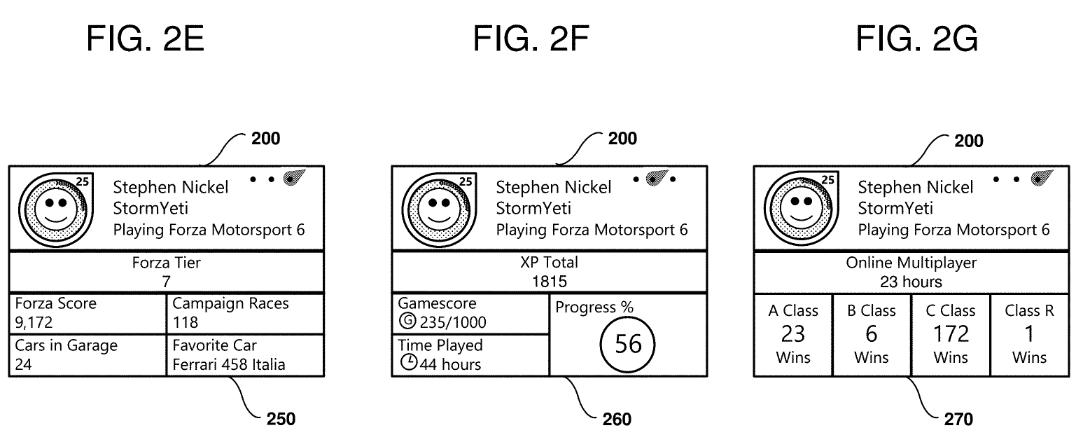

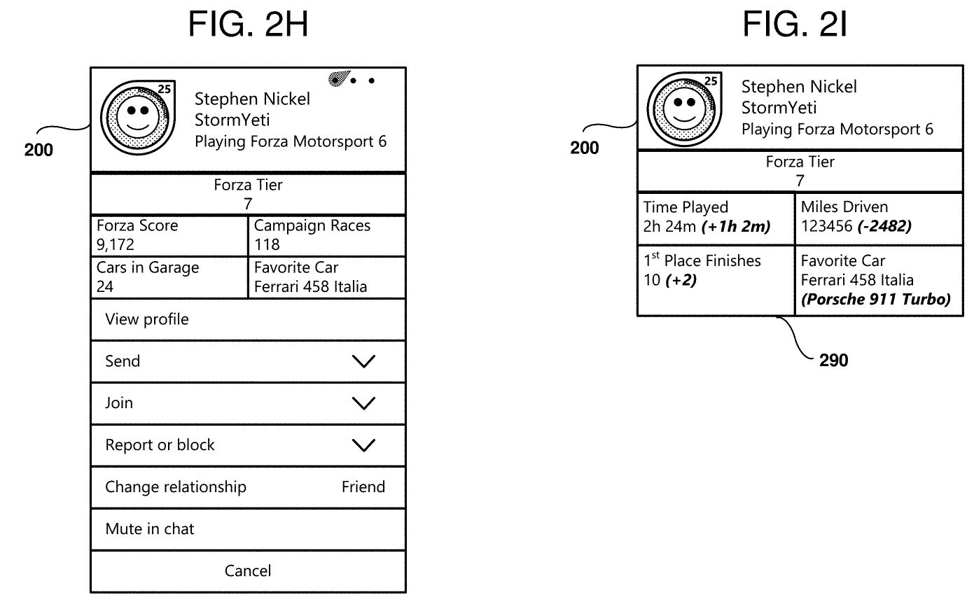

FIGS. 2A-2I illustrate an example of a user interface that can be used to provide an interactive control for browsing user statistics, displaying user statistics, and/or initiating or launching selected applications with the interactive control, as can be performed in certain examples of the disclosed technology. For example, the computing devices and gaming console discussed above regarding FIG. 1 can be coupled to a suitable display, for example an LCD or LED monitor display, a touch screen display, a projection display, or other suitable display technology in order to display the depicted graphic user interface.

FIG. 2A illustrates an example of an interactive control interface 200 in a first display mode. In this display mode, an interface window or frame displays an avatar 205 for a particular user, and certain information about the user including, for example the user's username, actual name, and current activity (here, “playing Forza 6”). Data displayed in the interactive control interface 200 of FIG. 2A includes identity data (e.g., the user name “StormYeti” and the user's actual name, credibility data (e.g., including the users' game score 345678, and personalization elements (e.g., the user's avatar). Further, the interactive control interface 200 can also display activity data (e.g., data indicating recentness, frequency, and/or duration of a user's application activities), skill data (e.g., data indicating a user's proficiency, such as proficiency in using an application or playing a game), and/or progression data (e.g., data indicating milestones or other accomplishments achieved in an application such as a game). Additional examples of these three different types of data are discussed further below with respect to other display modes of the control interface.

FIG. 2B illustrates another aspect of the interactive control interface 200 in a second display mode. The second display mode may be entered from the first based on, for example, automatically, based on the user activity or application context, or after receiving input from a user to initiate further browsing of the selected user. As shown, the window or frame of the interface 200 has been expanded in order to display a number of individual statistics for a particular application. In this example, the application is a car racing game, Forza Motorsports 6. The interface displays individual statistics including the amount of time the user has spent playing the game, the number of miles driven in the game, the number of first place finishes achieved by the user, and a favorite car used by the user in the game. The interactive control interface 200 can be prompted to display the data using input including mouse clicks, touch screen touches, touch screen taps or holds, audio input including verbal commands, gestures interpreted by a motion sensing camera, or other suitable technologies for using the illustrated GUI.

FIG. 2C illustrates another aspect of the interactive control interface 200 after additional interface elements have been revealed contextually, for example based on receiving user input, elapsed amount of time, or other suitable condition. These additional fields include viewing interfaces for interacting with social media. For example, time played, miles driven, and number of first place finishes are examples of credibility data, as they indicate the relative ability and effort for the displayed player, from which a user's ability and other game attributes may be inferred.

FIG. 2D illustrates another aspect of the interactive control interface 200 displaying a plurality of four interactive controls 200, 210, 220, and 230, each of the interactive controls corresponding to a different user in a multi-application system. For example, each of four users can send data to an application hub system via a computer network and the data can be collected by the application hub system and displayed on individual synchronized user displays as shown.

As shown in FIG. 2D, the first interactive control 200 displays information about a first user including their real name and username, along with their current activity, which is playing the game Forza Motorsports 6. The interface 200 further shows that the first user is in Tier 7, according to the Forza Motorsports 6 application. A second interactive control interface 210 is provided for a second user, which displays the corresponding user's avatar, username, real name, and current activity. As shown, the second user last played Forza Motorsports 6, but is not currently active in the system. A third interactive control interface 230 is shown for a third user, who has their own avatar, username, and current activity displayed. As shown, the third user is interacting with a different application, and is watching a video. Attributes of the user from a third application, Fable Legends, are shown along with game-specific statistics (here, the number of chickens kicked, 954) in this third application. A fourth interactive control interface is shown for a fourth user including that user's avatar and current activity, which is playing the game Fallout 4, another example of an application. The user can use various user interfaces to browse each of the individual interactive control interfaces and expand a selected one or more of these control interfaces in order to determine more about the credibility, personality, and other attributes of a particular user based on their activities in the plurality of applications.

Additional aspects of browsing a user's data using the interactive control interface 200 are illustrated in FIGS. 2E, 2F, and 2G. As shown, when in a first display mode 250, individual statistics for the selected first user for an individual game are displayed. The statistics to be displayed can be specified by a developer of the particular application and provided to an application hub system using a TCUI. The user can interact with the control in order to change the display to a second display mode 260 as shown at FIG. 2F. As shown, the second display mode includes aggregate statistics for the same user across a plurality of two or more applications, for example two or more video games. The aggregated statistics indicate a composite game score which indicates that user's skill, credibility, and/or progress across a number of different games and other cross-application activities. The control interface 200 further illustrates a total amount of time that the first user has been playing games with the system, as well as the user's total progress in completing accomplishments across the plurality of games. FIG. 2G illustrates the control interface 200 in a third display mode 270 showing additional aggregated statistics for the user across two or more applications. This information includes the amount of time the user spends playing online multi-player games, as well as the number of wins that the user has achieved in various classes of games.

FIG. 2H illustrates another aspect of the interactive control interface 200 after a user has provided input to reveal menus associated with certain system wide actions, including social media actions.

FIG. 2I illustrates another aspect of the interactive control interface 200, which can display comparison data 290 including comparative statistics between the interface user and other users of the system. As shown, the browsed users has spent 1 hour, 2 minutes more time playing the game, driven 2,482 fewer miles, achieved two more first place finishes, and has a different favorite car in comparison to the interface user. Additional relative or absolute comparisons can be displayed.

### IV. SECOND EXAMPLE USER INTERFACE PROVIDING AN INTERACTIVE CONTROL

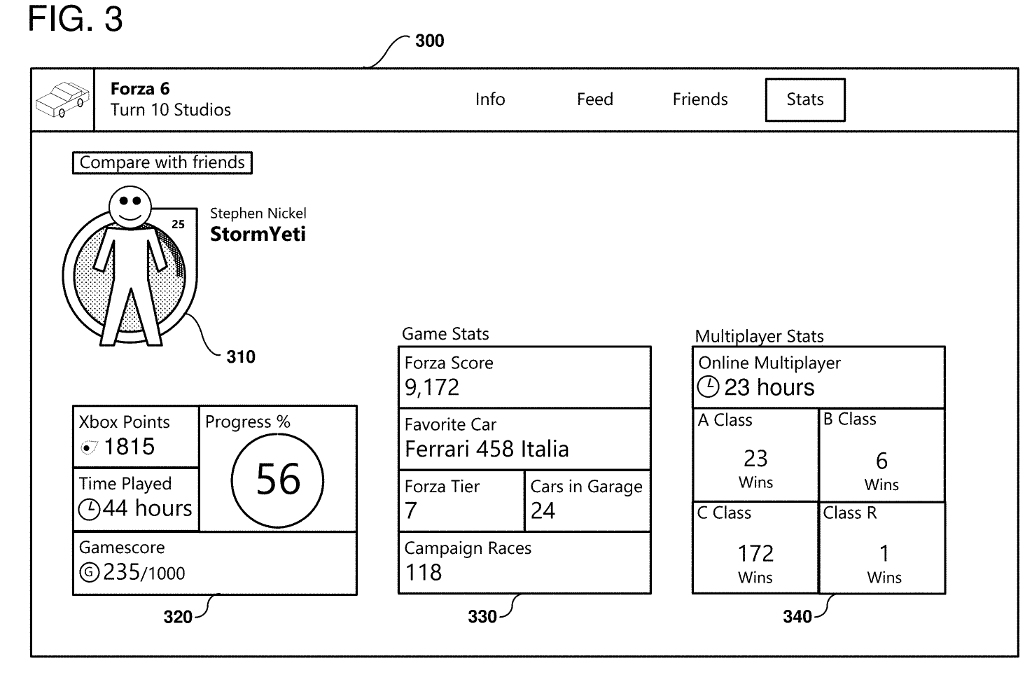

FIG. 3 is a diagram that illustrates an example interactive control interface 300 that can be used to implement certain examples of the disclosed technology. For example, the interactive control interface 300 can be brought up by the user by providing additional input to the interactive control interface 200 discussed about regarding FIGS. 2A-2I. In other examples, the interactive control interface 300 is a different interface provided for the user. As shown in FIG. 3, in this larger control interface 300, a larger user avatar 310 is displayed and application-specific and aggregated statistics are shown simultaneously in the display. For example, a collection of aggregated statistics 320 is shown to the left, while application-specific statistics are shown in the middle column 330, and a third set of statistics, multi-player statistics are shown in the right-hand column 340. Such a display can allow a user of the control interface 300 to evaluate credibility of a user based on the amount and type of gaming that the particular user performs.

### V. THIRD EXAMPLE USER INTERFACE PROVIDING AN INTERACTIVE CONTROL

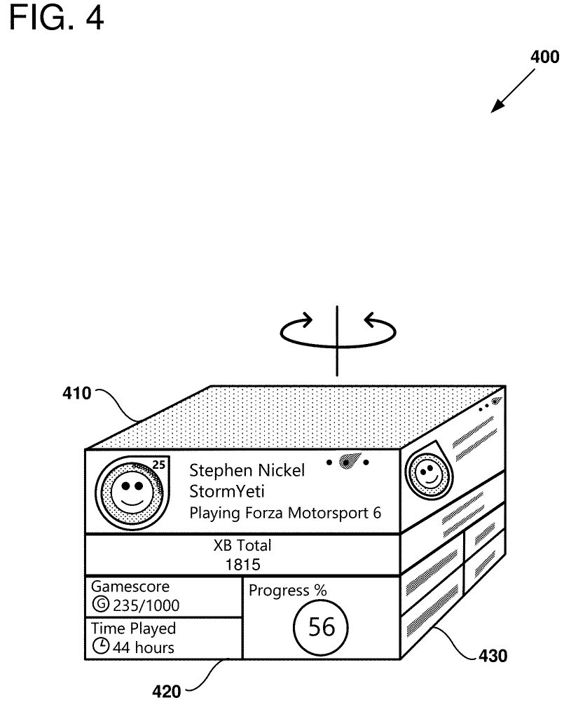

FIG. 4 is a diagram 400 illustrating an alternate example of an interactive control interface 410 as can be used in certain examples of the disclosed technology. In the illustrated example, the interface 410 displays one side of an n-dimensional interface cube at a time. A user can provide suitable input such as gestures, swipes, keystrokes, or other suitable input in order to visually rotate the interface cube from displaying a first side 420 to then displaying a second side 430 of different statistics. For example, one side 420 of the cube displays aggregate statistics for the user, while the second side 430 of the cube display statistics for the user specific to a single application such as a game. In some examples, the interface displays the cube as having a fixed number of sides (e.g., four sides). In other examples, the control interface is configured to display a different, or unlimited number of, “sides” that display particular views of user information.

### VI. FOURTH EXAMPLE USER INTERFACE PROVIDING AN INTERACTIVE CONTROL

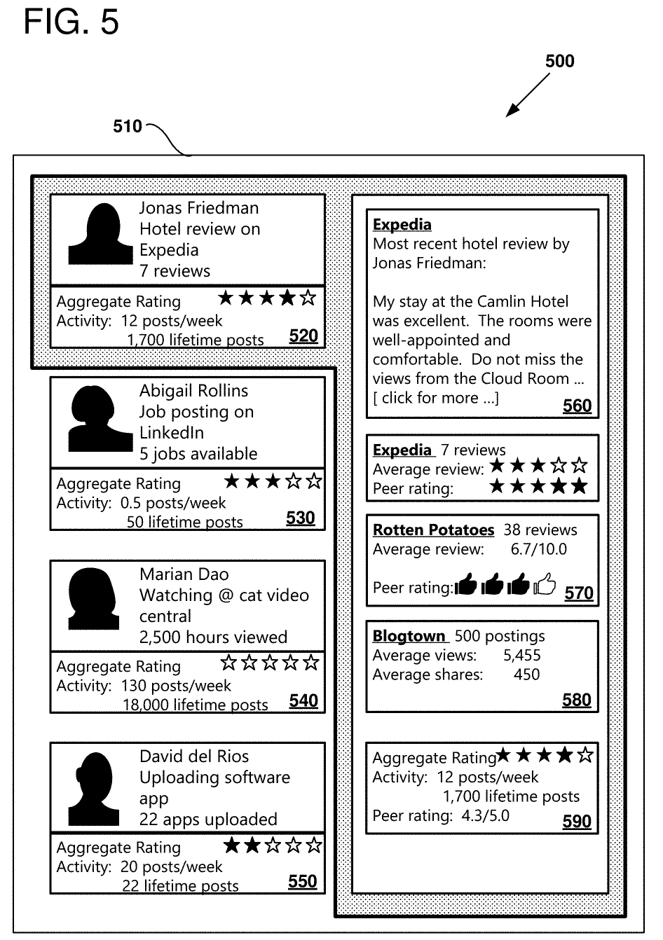

FIG. 5 is a diagram 500 illustrating an example display of an interactive control interface 510 as can be used in certain examples of the disclosed technology. In the illustrated example, applications other than games are displayed. Four different system users have respective interface frames 520, 530, 540, and 550 in the interactive control interface 510. These interface frames display a limited amount of application data for the user, including individual application data, as well as aggregated data. For example, for the first frame 520, the user's last activity was entering a hotel review on a travel website, and the user has submitted a total of seven reviews to the travel website. An aggregate rating of four stars for the user is also displayed, reflecting the user's activity across a number of different applications. The display also shows the number of posts per weeks that the user makes, and the number of posts that the user has made over the period that they have been enrolled in the system. By selecting the first user's interface frame 520, additional data can be expanded as shown on the right-hand side frame 560. Not only is additional data associated with the travel application displayed, but application data for other applications including a second application frame 570 and a third application frame 580 are displayed. Further, an aggregated display 590 is shown with additional data aggregated across a number of different applications in which the user participates.

As will be readily understood to one of ordinary skill in the relevant art, the technologies disclosed herein can be extended beyond games and other user-centric applications to other entities, such as clubs, tournaments, publishers, software publishers, content creators, etc.

### VII. EXAMPLE METHOD OF DISPLAYING DATA WITH AN INTERACTIVE CONTROL

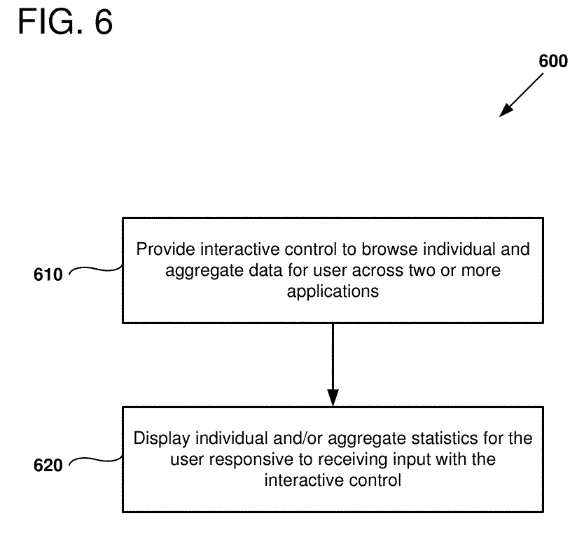

FIG. 6 is a flowchart 600 outlining an example method displaying data for a user with an interactive control. For example, devices such as those discussed above regarding FIG. 1 can be used to implement the method of FIG. 6.

At process block 610, an interactive control is provided to browse individual and aggregate data for a user across two or more applications. For example, both application-specific and system-wide data can be used to browse and display for an individual user. In some examples, a device interacts with an application hub system in order to query and receive the data to be browsed. In some examples, the interactive control is configured to browse the data such as statistics without launching an application associated with the statistics. In some examples, the interactive control is further configured to provide an interface for browsing social media activity for a selected user. The social media activity can include, but is not limited to, one or more of the following: interacting with a hangout, viewing an activity feed, viewing live video content, or viewing stored video content. In some examples, the interactive control is further configured to provide an interface for identifying multiple-player gaming sessions, enter a gaming lobby, to form a team within a multi-player game, or other application. Some examples, the interactive controls further configured to display game playing statistics for a selected user including, but not limited to, at least one or more of the following: a score for an individual session of a game, a score combined across multiple sessions of a game, an indicator of a player's progress through a game, an initiator of player achievements in a game, an indicator of progress in a game for different modes of game play, an indicator of progress in a game for different difficulty levels of a game, an amount of time spent playing an individual game, or combined amount of time spent playing two or more games.

At process block 620, individual and/or aggregate data such as statistics for a user are displayed responsive to receiving input with the interactive control, or automatically based on contextual information. For example, a user may click in an area of an interface frame or window to expand and display the individual or aggregate data. In other examples, other user interface techniques such as a touch screen swipe or a gesture detected by a camera, or voice commands, can be used to cause the interactive control to display the data. In some examples, the interactive control is configured to browse the data such as statistics without launching a game associated with the statistics.

### VIII. EXAMPLE METHOD OF DISPLAYING CREDIBILITY DATA AND LAUNCHING APPLICATIONS WITH AN INTERACTIVE CONTROL

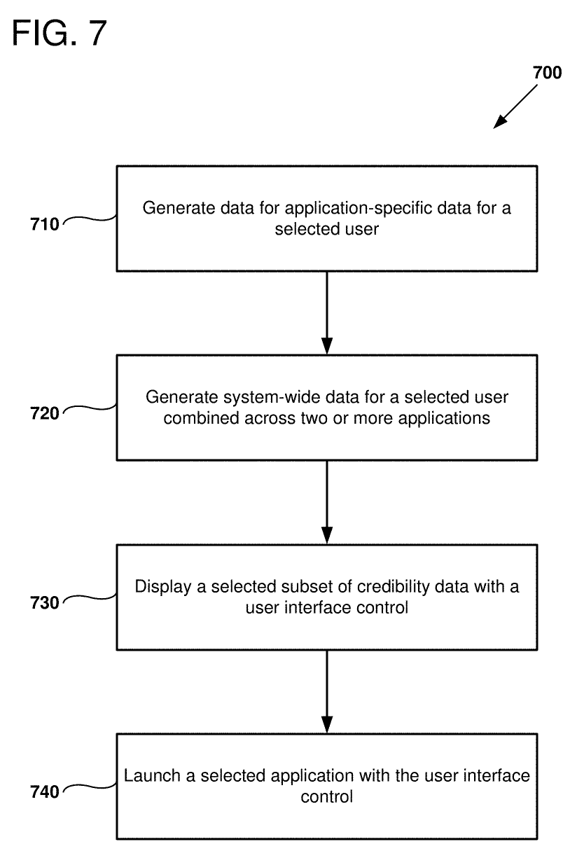

FIG. 7 is a flowchart 700 outlining an example method of displaying credibility and personalization data and launching applications with a user interface control, as can be performed in certain examples of the disclosed technology. For example, the devices discussed above regarding FIG. 1 can be used to implement the method outlined in FIG. 7.

At process block 710, application-specific data for a user is generated. For example, an application can be configured by a developer or a user to collect and provide data specific to an application that can be used to, for example, evaluate credibility or other criteria about a user. For example, a video game developer can specify certain achievements, tasks, points, time spent playing a game, or other suitable data to be generated. The data can be sent to an application hub system that can store the data until requested by a computing device providing an interactive control interface.

At process block 720, system-wide data for a user is generated by combining data received from two or more applications. For example, the amount of time spent playing the game, the amount of time spent playing in a multi-user mode, the number of actions taken, or other suitable data can be gathered and sent to an application hub system. In some examples, a different actor is used to configure the application hub system to generate the system-wide data than individual applications.

At process block 730, a selected subset of credibility data generated at process block 710 and 720 is displayed with a user interface control. In some examples, the control provides interface to view only application-specific or system-wide data at a particular time. While in other examples, the data is combined into a single display. Browsing capability can be provided to allow a user to browse across a number of different users, viewing their application-specific and system-wide data in order to assess factors such as credibility, skill, or other attributes of a user as observed over time by a number of applications.

At process block 740, a selected application is launched with the user interface control. For example, based on viewing the data at process block 730, a user can select another user believed to be most suitable for interacting with in an application such as a game.

### IX. EXAMPLE METHOD OF DISPLAYING STATISTICS WITH A GAME

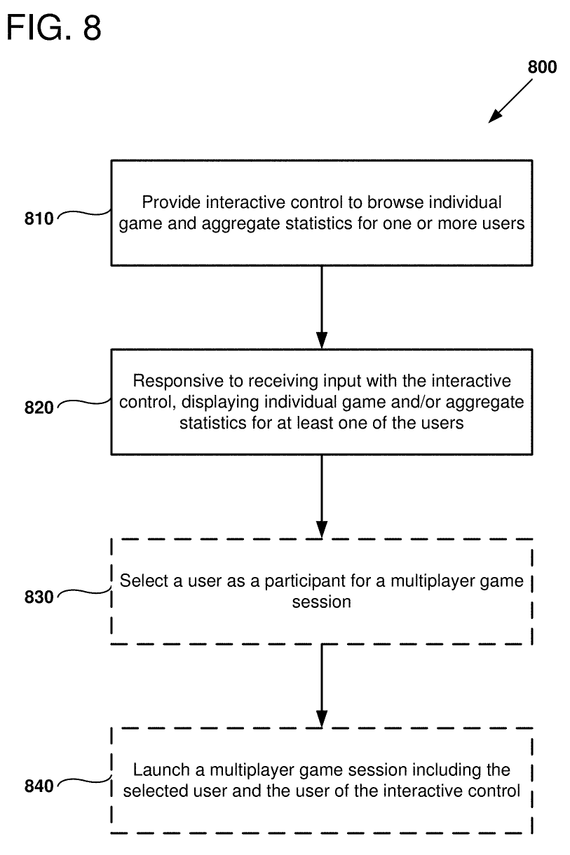

FIG. 8 is a flowchart 800 outlining an example method of displaying statistics for a game, as can be performed in certain examples of the disclosed technology. Systems such as those discussed above at FIG. 1 can be used to implement the disclosed method.

At process block 810, an interactive control is provided to browse individual game and aggregate statistics for one or more users in a game system. For example, an application hub can provide a user interface that is used to browse statistics for a number of different games.

At process block 820, responsive to receiving input with the interactive control, an application hub system sends data to a computing device connected to a display and individual game and/or aggregate statistics are displayed for at least one of the users. For example, control interfaces such as those discussed above regarding FIG. 2 can be used to interact with the display data.

At process block 830, a user is selected as a participant for a multi-player game session. In some examples, the interactive control provides launch capability allowing a user to select and request a particular user of the system to join a multi-player game session. In some examples, the user and the selected user are at first in the game session, while in other examples, the user and the selected user are participants on a cooperative team.

At process block 840, a multi-player game session is launched including the selected user and the user of the interactive control. Control of the system can pass to the game, which is a separate application than an application used to browse through statistics and users at process blocks 810 through 830. Thus, a single common application hub is provided.

### X. EXAMPLE METHOD OF PROVIDING DATA VIA A TITLE-CALLABLE USER INTERFACE (TCUI)

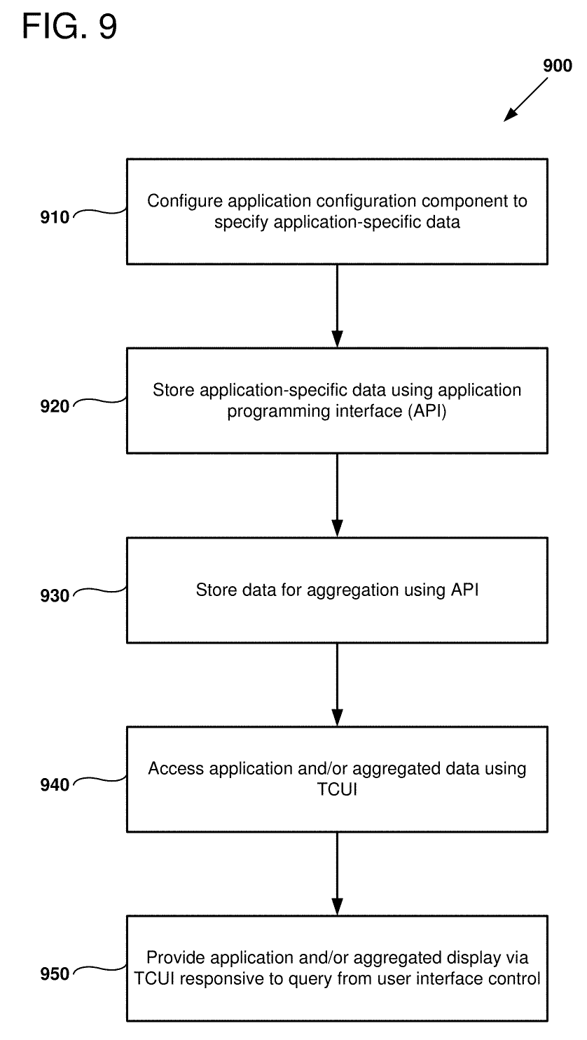

FIG. 9 is a flowchart 900 outlining and example method of providing application and aggregated display data via an application programming interface (API) including a title-callable user interface (TCUI), as can be performed in certain examples of the disclosed technology. A TCUI provides consistency across multiple different applications and familiarity in the user interface for these disparate applications. In some examples, the TCUI is a subset of the API, in other examples, a separate TCUI is provided in lieu of an API.

At process block 910, an application configuration component is configured to specify application-specific data to be collected. For example, an application developer can create a configuration file that specifies statistics within an application or to be collected. In other examples, the configuration component is configured by a user of the application.

At process block 920, application-specific data based on the configuration component is stored using an API. For example, an application developer can include procedure calls defined using the API in order to send data to an application hub system that can then collect the data in a standardized format. This allows for applications from a number of different developers to be easily integrated and their data aggregated by the application hub system.

At process block 930, aggregation data is stored using the API. In some examples, an application hub system can query an application for statistics that it is collecting to generate the aggregation data. In other examples, the application hub system collects statistics and other data from each of the applications and stores it.

At process block 940, application and/or aggregated data is accessed using a TCUI. For example, the TCUI can define database or storage queries that allow for access to the data using a common interface. For example, a first organization can provide an API used to generate and store aggregated data for multiple applications. The API allows for a standardized way for different applications to provide context data that can be meaningfully aggregated. When another organization wants to display a user interface including at least a portion of the aggregated context data, a TCUI can be called, providing a user interface with a similar look and feel across multiple different applications. In some examples, the calling application may have no direct access to the displayed data, as the TCUI functionality is provided by a separate system component (e.g., an application hub server).

At process block 950, application and/or aggregated data is displayed using a TCUI responsive to a query from the user interface control. By providing a common TCUI for multiple applications, the developer of user interface control does not need to tailor the control to each individual application, but can use the general TCUI to perform this function. In some examples, the TCUI includes executable functions to cause indication of user interface components displaying a selected portion of the usage data without requiring the selected portion to be specified by respective calling application code.

### XI. EXAMPLE COMPUTING ENVIRONMENT

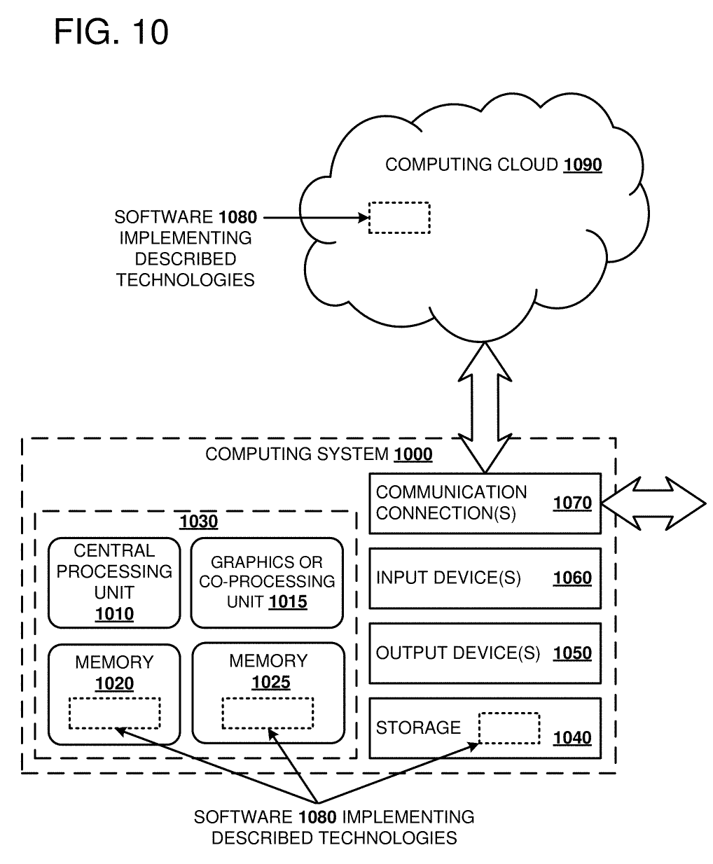

FIG. 10 depicts a generalized example of a suitable computing system 1000 in which embodiments, techniques, and technologies can be implemented. The computing system 1000 is not intended to suggest any limitation as to scope of use or functionality, as the innovations may be implemented in diverse general-purpose or special-purpose computing systems. For example, the disclosed technology may be implemented with other computer system configurations, including hand held devices, multi-processor systems, programmable consumer electronics, network PCs, minicomputers, mainframe computers, and the like. The disclosed technology may also be practiced in distributed computing environments where tasks are performed by remote processing devices that are linked through a communications network. In a distributed computing environment, program modules (including executable instructions) may be located in both local and remote memory storage devices. By way of further example, the computing system 1000 can be used to implement disclosed application hub systems and to provide interactive controls disclosed herein.

With reference to FIG. 10, the computing system 1000 includes one or more processing units 1010, 1015 and memory 1020, 1025. In FIG. 10, this basic configuration 1030 is included within a dashed line. The processing units 1010, 1015 execute computer-executable instructions. A processing unit can be a general-purpose central processing unit (CPU), processor in an application-specific integrated circuit (ASIC), or any other type of processor. In a multi-processing system, multiple processing units execute computer-executable instructions to increase processing power. For example, FIG. 10 shows a central processing unit 1010 as well as a graphics processing unit or co-processing unit 1015. The tangible memory 1020, 1025 may be volatile memory (e.g., registers, cache, RAM), non-volatile memory (e.g., ROM, EEPROM, flash memory, etc.), or some combination of the two, accessible by the processing unit(s). The memory 1020, 1025 stores software 1080 implementing one or more innovations described herein, in the form of computer-executable instructions suitable for execution by the processing unit(s).

A computing system may have additional features. For example, the computing system 1000 includes storage 1040, one or more input devices 1050, one or more output devices 1060, and one or more communication connections 1070. An interconnection mechanism (not shown) such as a bus, controller, or network interconnects the components of the computing system 1000. Typically, operating system software (not shown) provides an operating environment for other software executing in the computing system 1000, and coordinates activities of the components of the computing system 1000.

The tangible storage 1040 may be removable or non-removable, and includes magnetic disks, magnetic tapes or cassettes, CD-ROMs, DVDs, or any other medium which can be used to store information and which can be accessed within the computing system 1000. The storage 1040 stores instructions for the software 1080 implementing one or more innovations described herein.

The input device(s) 1050 may be a touch input device such as a keyboard, mouse, pen, or trackball, a voice input device, a scanning device, or another device that provides input to the computing system 1000. For video encoding, the input device(s) 1050 may be a camera, video card, TV tuner card, or similar device that accepts video input in analog or digital form, or a CD-ROM or CD-RW that reads video samples into the computing system 1000. The output device(s) 1060 may be a display, printer, speaker, CD-writer, or another device that provides output from the computing system 1000.

The communication connection(s) 1070 enable communication over a communication medium to another computing entity. The communication medium conveys information such as computer-executable instructions, audio or video input or output, or other data in a modulated data signal. A modulated data signal is a signal that has one or more of its characteristics set or changed in such a manner as to encode information in the signal. By way of example, and not limitation, communication media can use an electrical, optical, RF, or other carrier.

The innovations can be described in the general context of computer-executable instructions, such as those included in program modules, being executed in a computing system on a target real or virtual processor. Generally, program modules include routines, programs, libraries, objects, classes, components, data structures, etc. that perform particular tasks or implement particular abstract data types. The functionality of the program modules may be combined or split between program modules as desired in various embodiments. Computer-executable instructions for program modules may be executed within a local or distributed computing system. In general, a computing system or computing device can be local or distributed, and can include any combination of special-purpose hardware and/or general-purpose hardware with software implementing the functionality described herein.

Some embodiments of the disclosed methods can be performed using computer-executable instructions implementing all or a portion of the disclosed technology in a computing cloud 1090. For example, disclosed servers are located in the computing environment, or the disclosed compilers can be executed on servers located in the computing cloud 1090. In some examples, the disclosed compilers execute on traditional central processing units (e.g., RISC or CISC processors).

Computer-readable media are any available media that can be accessed within a computing system 1000 environment. By way of example, and not limitation, with the computing system 1000 environment, computer-readable media include memory 1020 and/or storage 1040. As should be readily understood, the term computer-readable storage media includes the media for data storage such as memory 1020 and storage 1040, and not transmission media such as modulated data signals.

### XII. EXAMPLE MOBILE DEVICE

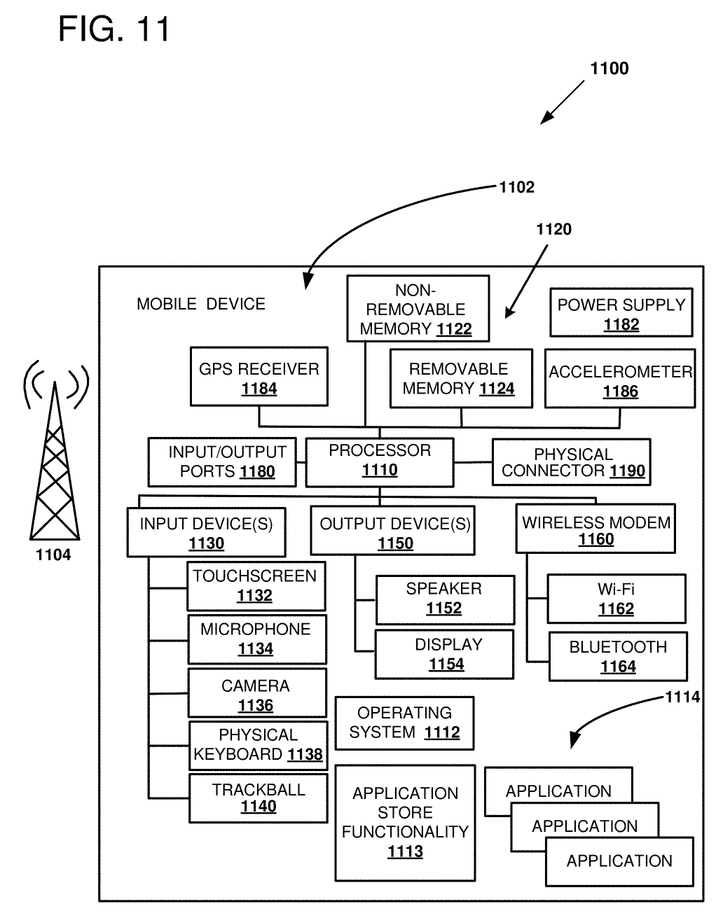

FIG. 11 is a system diagram depicting an example mobile device 1100 including a variety of optional hardware and software components, shown generally at 1102. Any components 1102 in the mobile device can communicate with any other component, although not all connections are shown, for ease of illustration. The mobile device can be any of a variety of computing devices (e.g., cell phone, smartphone, handheld computer, Personal Digital Assistant (PDA), etc.) and can allow wireless two-way communications with one or more mobile communications networks 1104, such as a cellular, satellite, or other network.

The illustrated mobile device 1100 can include a controller or processor 1110 (e.g., signal processor, microprocessor, ASIC, or other control and processing logic circuitry) for performing such tasks as signal coding, data processing, input/output processing, power control, and/or other functions. An operating system 1112 can control the allocation and usage of the components 1102 and support for one or more application programs 1114. The application programs can include common mobile computing applications (e.g., email applications, calendars, contact managers, web browsers, messaging applications), or any other computing application. Functionality 1113 for accessing an application store can also be used for acquiring and updating application programs 1114.

The illustrated mobile device 1100 can include memory 1120. Memory 1120 can include non-removable memory 1122 and/or removable memory 1124. The non-removable memory 1122 can include RAM, ROM, flash memory, a hard disk, or other well-known memory storage technologies. The removable memory 1124 can include flash memory or a Subscriber Identity Module (SIM) card, which is well known in GSM communication systems, or other well-known memory storage technologies, such as “smart cards.” The memory 1120 can be used for storing data and/or code for running the operating system 1112 and the applications 1114. Example data can include web pages, text, images, sound files, video data, or other data sets to be sent to and/or received from one or more network servers or other devices via one or more wired or wireless networks. The memory 1120 can be used to store a subscriber identifier, such as an International Mobile Subscriber Identity (IMSI), and an equipment identifier, such as an International Mobile Equipment Identifier (IMEI). Such identifiers can be transmitted to a network server to identify users and equipment.

The mobile device 1100 can support one or more input devices 1130, such as a touchscreen 1132, microphone 1134, camera 1136, physical keyboard 1138 and/or trackball 1140 and one or more output devices 1150, such as a speaker 1152 and a display 1154. Other possible output devices (not shown) can include piezoelectric or other haptic output devices. Some devices can serve more than one input/output function. For example, touchscreen 1132 and display 1154 can be combined in a single input/output device.

The input devices 1130 can include a Natural User Interface (NUI). An NUI is any interface technology that enables a user to interact with a device in a “natural” manner, free from artificial constraints imposed by input devices such as mice, keyboards, remote controls, and the like. Examples of NUI methods include those relying on speech recognition, touch and stylus recognition, gesture recognition both on screen and adjacent to the screen, air gestures, head and eye tracking, voice and speech, vision, touch, gestures, and machine intelligence. Other examples of a NUI include motion gesture detection using accelerometers/gyroscopes, facial recognition, 3D displays, head, eye, and gaze tracking, immersive augmented reality and virtual reality systems, all of which provide a more natural interface, as well as technologies for sensing brain activity using electric field sensing electrodes (EEG and related methods). Thus, in one specific example, the operating system 1112 or applications 1114 can comprise speech-recognition software as part of a voice user interface that allows a user to operate the device 1100 via voice commands Further, the device 1100 can comprise input devices and software that allows for user interaction via a user's spatial gestures, such as detecting and interpreting gestures to provide input to a gaming application.

A wireless modem 1160 can be coupled to an antenna (not shown) and can support two-way communications between the processor 1110 and external devices, as is well understood in the art. The modem 1160 is shown generically and can include a cellular modem for communicating with the mobile communication network 1104 and/or other radio-based modems (e.g., Bluetooth 1164 or Wi-Fi 1162). The wireless modem 1160 is typically configured for communication with one or more cellular networks, such as a GSM network for data and voice communications within a single cellular network, between cellular networks, or between the mobile device and a public switched telephone network (PSTN).

The mobile device can further include at least one input/output port 1180, a power supply 1182, a satellite navigation system receiver 1184, such as a Global Positioning System (GPS) receiver, an accelerometer 1186, and/or a physical connector 1190, which can be a USB port, IEEE 1394 (FireWire) port, and/or RS-232 port. The illustrated components 1102 are not required or all-inclusive, as any components can be deleted and other components can be added.

### XIII. CLOUD-SUPPORTED ENVIRONMENT

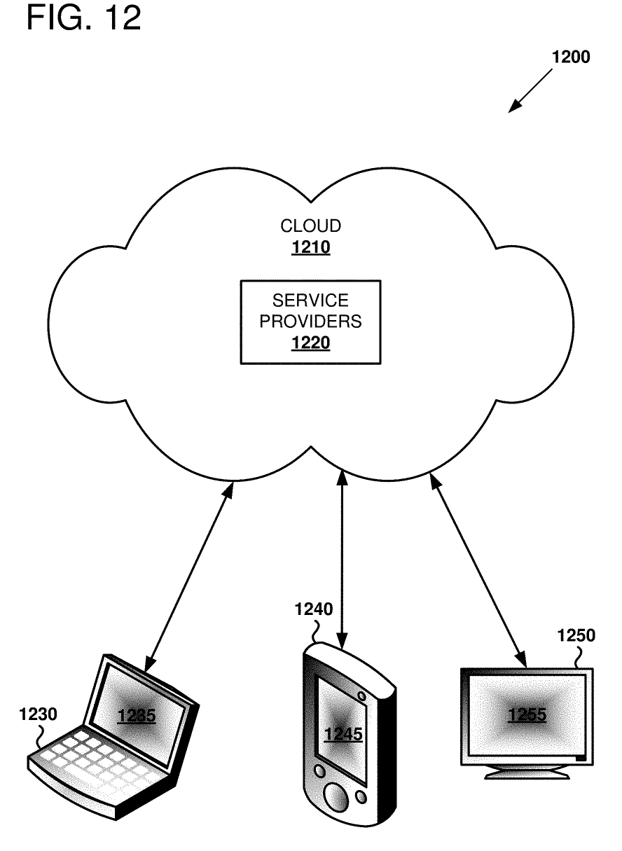

FIG. 12 illustrates a generalized example of a suitable cloud-supported environment 1200 in which described embodiments, techniques, and technologies may be implemented. In the example environment 1200, various types of services (e.g., computing services) are provided by a cloud 1210. For example, the cloud 1210 can comprise a collection of computing devices, which may be located centrally or distributed, that provide cloud-based services to various types of users and devices connected via a network such as the Internet. The implementation environment 1200 can be used in different ways to accomplish computing tasks. For example, some tasks (e.g., processing user input and presenting a user interface) can be performed on local computing devices (e.g., connected devices 1230, 1240, 1250) while other tasks (e.g., storage of data to be used in subsequent processing) can be performed in the cloud 1210.

In example environment 1200, the cloud 1210 provides services for connected devices 1230, 1240, 1250 with a variety of screen capabilities. Connected device 1230 represents a device with a computer screen 1235 (e.g., a mid-size screen). For example, connected device 1230 could be a personal computer such as desktop computer, laptop, notebook, netbook, or the like. Connected device 1240 represents a device with a mobile device screen 1245 (e.g., a small size screen). For example, connected device 1240 could be a mobile phone, smart phone, personal digital assistant, tablet computer, and the like. Connected device 1250 represents a device with a large screen 1255. For example, connected device 1250 could be a television screen (e.g., a smart television) or another device connected to a television (e.g., a set-top box or gaming console) or the like. One or more of the connected devices 1230, 1240, 1250 can include touchscreen capabilities. Touchscreens can accept input in different ways. For example, capacitive touchscreens detect touch input when an object (e.g., a fingertip or stylus) distorts or interrupts an electrical current running across the surface. As another example, touchscreens can use optical sensors to detect touch input when beams from the optical sensors are interrupted. Physical contact with the surface of the screen is not necessary for input to be detected by some touchscreens. Devices without screen capabilities also can be used in example environment 1200. For example, the cloud 1210 can provide services for one or more computers (e.g., server computers) without displays.

Services can be provided by the cloud 1210 through service providers 1220, or through other providers of online services (not depicted). For example, cloud services can be customized to the screen size, display capability, and/or touchscreen capability of a particular connected device (e.g., connected devices 1230, 1240, 1250).

In example environment 1200, the cloud 1210 provides the technologies and solutions described herein to the various connected devices 1230, 1240, 1250 using, at least in part, the service providers 1220. For example, the service providers 1220 can provide a centralized solution for various cloud-based services. The service providers 1220 can manage service subscriptions for users and/or devices (e.g., for the connected devices 1230, 1240, 1250 and/or their respective users).

### XIV. ADDITIONAL EXAMPLES OF THE DISCLOSED TECHNOLOGY

Additional examples of the disclosed subject matter are discussed herein in accordance with the examples discussed above.

In some examples of the disclosed technology, an application hub system provides a user interface control to invoke a plurality of applications including: a browser component configured to generate display data for a selected portion of credibility data for a selected entity of a plurality of entities, a configuration component configured to select a subset of the credibility data for generating the display by the browser component, and an application invocation component configured to launch a selected one of the plurality of applications, the selected application being selected with the user interface control provided by the application hub system. The credibility data can include application-specific data for the selected user for an associated at least one of the plurality of applications and/or system-wide data including statistics of entity activity for the selected entity combined across two or more of the plurality of applications. In some examples, the credibility data can include at least one or more of the following: activity data (e.g., data indicating recentness, frequency, and/or duration of a user's application activities), skill data (e.g., data indicating a user's proficiency, such as proficiency in using an application or playing a game), and/or progression data (e.g., data indicating milestones or other accomplishments achieved in an application such as a game). In some examples, additional types of data are displayed in addition to, or instead of, the credibility data, including: identity data (a username, a user's real or screen name, location, account number, etc.), personalization elements (e.g., a user's avatar, display preferences, associated entities, etc.), activity data (e.g., data indicating recentness, frequency, and/or duration of a user's application activities), skill data (e.g., data indicating a user's proficiency, such as proficiency in using an application or playing a game), and/or progression data (e.g., data indicating milestones or other accomplishments achieved in an application such as a game).

In some examples, the configuration component is further configured to access the application-specific data without invoking the associated application. In some examples, at least a portion of the application-specific or system-wide data are displayed within one or more of the plurality of applications. In some examples, the application hub system is configured to execute computer-readable instructions for each of the plurality of applications. In other examples, the application hub systems serves only as a browsing/launching platform for applications hosted on other devices.

In some examples, a user interface device coupled to the application hub system that is configured to display the generated display data to a user with a graphical user interface. In some examples, a user interface device is coupled to the application hub system configured to allow a user to select display of the application-specific data or of the system-wide data responsive to input received with the user interface device.

In some examples, the application-specific data comprises at least one or more of the following data specific to a particular application: metrics defined by each respective application, data for user actions performed in a single-user mode of the application, data for user actions performed in a multiple-user mode of the application, or data for user achievements. In some examples, the system-wide data comprises at least one or more of the following data that is gathered across multiple applications: data indicating an amount of time playing a game, data indicating a composite score of gamer ability, or data indicating a number of victories or other statistics. In some examples of the application hub system, the browser component includes credibility interface means for interactively viewing, comparing, and/or assessing the credibility data for a particular user. In some examples, other entities are browsed instead of or in addition to users (e.g., organizations, teams, or other entities).

In some examples, the user interface control can have multiple displays modes including those discussed above regarding FIGS. 2A-2I, 3, and/or 4. For example, the display modes may be changed, automatically, based on the user activity or application context (e.g., an elapsed amount of time), or after receiving input from a user to initiate further browsing of the selected user. Received input can include mouse clicks, touch screen touches, touch screen taps or holds, audio input including verbal commands, gestures interpreted by a motion sensing camera, or other suitable technologies.

In some examples, the user interface control displays information for one entity or user at a time. In other examples, information for multiple entities or users is displayed concurrently. In addition to application-specific and system-wide, aggregated data, other system wide actions, such as activity in other applications, such as social media actions can also be displayed. In some examples, comparison data is also displayed, including comparative statistics between the interface user and other users of the system. In some examples, the interface displays one side of an n-dimensional interface “cube” at a time.

In some examples, different system users or entities have context data displayed in respective interface frames of the interactive control interface, including individual application data, as well as aggregated data. By selecting one of the interface frames, additional data can be displayed in an expanded view. In some examples, the additional data is displayed automatically based on contextual information.

In some examples of the disclosed technology, a method of displaying a contextual information for an entity associated with a plurality of applications includes providing an interactive control to browse single statistics for a first entity associated with an individual application and aggregate statistics for the first entity across two or more applications, and responsive to input received with the interactive control, displaying at least one of the single statistics or aggregate statistics for the first entity. In some examples, the additional data is displayed automatically based on contextual information.

In some examples of the application hub system, the interactive control allows for browsing social media activity for the first user, the social media activity comprising at least one or more of the following: interacting with a hangout, viewing an activity feed, viewing live video content, viewing stored video content, and other interactive experiences. In some examples, the interactive control further provides an interface for identifying multiplayer gaming sessions, entering a gaming lobby, or forming a team, and other collaborative experiences.

In some examples, the interactive control is configured to browse statistics without launching an application associated with the statistics. In some examples, the interactive control is further configured to browse one or more of: credibility data, identity data, personalization elements, activity data, skill data, or progression data.

In some examples of the method, the first entity is a first user and at least one of the applications is a game. In some examples, the method further includes, responsive to input received with the interactive control, selecting the first user as a participant for a multiplayer game session. In some examples, responsive to a current context of one of the plurality of applications, the method further includes automatically launching a multiplayer application session, the session including the first entity and a user of the interactive control.

In some examples of the method, the interactive control further provides an interface for browsing social media activity for the first entity, the social media activity comprising at least one or more of the following: interacting with a hangout, viewing an activity feed, viewing live video content, or viewing stored video content.

In some examples, at least one of the applications is a game, and the interactive control further provides an interface for identifying multiplayer gaming sessions, entering a gaming lobby, or forming a team. In some examples, the interactive control is further configured to display game play statistics for a selected user, the game play statistics including at least one or more of the following: a score for an individual session of a game, a score combined across multiple sessions of a game, an indicator of a players progress through a game, an indicator of player achievements in a game, an indicator of a progress in a game for one or more different modes of game play, an indicator of a progress in a game for one or more different difficulty levels of game play, an amount of time spent playing an individual game, or an combined amount of time spent playing two or more games.

In some examples, disclosed user interface controls can be implemented with an API. For example, a method including accessing usage data for a plurality of applications with an application programming interface (API), each of the applications defining a respective portion of the usage data for aggregation by a multi-platform application server and accessing aggregate usage for two or more of the applications from a multi-platform application server.

In some examples, the API is a title callable user interface (TCUI) providing access to executable functions that when called cause invocation of graphical user interface components displaying a selected portion of the usage data without requiring the selected portion to be specified by computer-executable code for the respective application.

In some examples, the method further includes causing the server to display at least one or more of the following data: application-specific usage data, social activity data, or aggregated usage data collected across two or more of the applications. In some examples, the method further includes interactively browsing a user or group associated with the applications, and the server displays the data on a per-user or a per-group basis. In some examples, the method further includes launching a selected at least one of the applications in a cooperative mode between a first user and a user or a group associated with the selected applications.

In some examples, one or more computer-readable storage devices or memory storing computer-readable instructions that when executed by a computer, cause the computer to perform any one or more of the methods disclosed herein. In some examples, a system includes one or more processors coupled to the computer-readable storage devices or memory and one or more displays for implementing disclosed user interface controls. In some examples, user interface controls receive mouse clicks, touch screen touches, touch screen taps or holds, audio input including verbal commands, gestures interpreted by a motion sensing camera and coupled to the system processor(s).

In view of the many possible embodiments to which the principles of the disclosed subject matter may be applied, it should be recognized that the illustrated embodiments are only preferred examples and should not be taken as limiting the scope of the claims to those preferred examples. Rather, the scope of the claimed subject matter is defined by the following claims. We therefore claim as our invention all that comes within the scope of these claims.

We claim:

1. An application hub system providing a user interface control to invoke a plurality of applications, the system comprising:
a browser component configured to generate display data for a selected portion of credibility data for a selected entity of a plurality of entities, the credibility data comprising:
application-specific data for the selected entity for an associated at least one of the plurality of applications, and
system-wide data including statistics of entity activity for the selected entity combined across two or more of the plurality of applications;
a configuration component configured to select a subset of the credibility data for generating the display by the browser component; and
an application invocation component configured to launch a selected one of the plurality of applications, the selected application being selected with the user interface control provided by the application hub system.

2. The system of claim 1, wherein the configuration component is further configured to access the application-specific data without invoking its associated application.

3. The system of claim 1, wherein the application hub system is configured to execute computer-readable instructions for each of the plurality of applications.

4. The system of claim 1, further comprising:
a user interface device coupled to the application hub system, the user interface being configured to display the generated display data to a user with a graphical user interface.

5. The system of claim 1, further comprising:
a user interface device coupled to the application hub system, the user interface being configured to allow a user to select display of the application-specific data or of the system-wide data responsive to input received with the user interface device.

6. The system of claim 1, wherein the application-specific data comprises at least one or more of the following data specific to a particular application: metrics defined by each respective application, data for user actions performed in a single-user mode of the application, data for user actions performed in a multiple-user mode of the application, and data for user achievements.

7. The system of claim 1, wherein the system wide data comprises at least one or more of the following data that is gathered across multiple applications: data indicating an amount of time playing a game, data indicating a composite score of gamer ability, or data indicating a number of victories or other statistics.

8. The system of claim 1, wherein the browser component comprises credibility interface means for interactively viewing, comparing, and/or assessing the credibility data for a particular user.

9. A method of displaying a contextual information for an entity associated with a plurality of applications, the method comprising:
providing an interactive control to browse single statistics for a first entity associated with an individual application and aggregate statistics for the first entity across two or more applications; and
responsive to input received with the interactive control, displaying at least one of the single statistics or aggregate statistics for the first entity.

10. The method of claim 9, wherein the interactive control is configured to browse statistics without launching an application associated with the statistics.

11. The method of claim 10, wherein the interactive control is further configured to display at least one or more of the following: identity data, credibility data, personalization items, skill data, or progression data.

12. The method of claim 9, wherein the first entity is a first user and at least one of the applications is a game, the method further comprising:
responsive to input received with the interactive control, selecting the first user as a participant for a multiplayer game session.

13. The method of claim 9, further comprising:
responsive to a current context of one of the plurality of applications, automatically launching a multiplayer application session, the session including the first entity and a user of the interactive control.

14. The method of claim 9, wherein the interactive control further provides an interface for browsing social media activity for the first entity, the social media activity comprising at least one or more of the following: interacting with a hangout, viewing an activity feed, viewing live video content, or viewing stored video content.

15. The method of claim 9, wherein at least one of the applications is a game, and wherein the interactive control further provides an interface for identifying multiplayer gaming sessions, entering a gaming lobby, or forming a team.

16. The method of claim 9, wherein at least one of the applications is a game, and wherein the interactive control is further configured to display game play statistics for a selected user, the game play statistics including at least one or more of the following: a score for an individual session of a game, a score combined across multiple sessions of a game, an indicator of a players progress through a game, an indicator of player achievements in a game, an indicator of a progress in a game for one or more different modes of game play, an indicator of a progress in a game for one or more different difficulty levels of game play, an amount of time spent playing an individual game, or an combined amount of time spent playing two or more games.

17. One or more computer-readable storage devices or memory storing computer-readable instructions that when executed by a computer, cause the computer to perform a method, the instructions comprising:
instructions for accessing usage data for a plurality of applications with an application programming interface (API), wherein each of the applications can define a respective portion of the usage data for aggregation by a multi-platform application server; and
instructions for accessing aggregate usage for two or more of the applications from the multi-platform application server.

18. The computer-readable storage devices or memory of claim 17, wherein the API includes a title callable user interface (TCUI), the TCUI including executable functions that when called cause invocation of graphical user interface components displaying a selected portion of the usage data without requiring the selected portion to be specified by computer-executable code for the respective application.

19. The computer-readable storage devices or memory of claim 17, wherein the instructions further comprise instructions for interactively browsing a user or group associated with the applications, and wherein the server displays the data on a per-user or a per-group basis.

20. The computer-readable storage devices or memory of claim 17, wherein the instructions further comprise instructions for launching a selected at least one of the applications in a cooperative mode between a first user and a user or a group associated with the selected at least one application.
